(19) United States
(12) Patent Application Publication
(10) Pub. No.: US 2026/0229824 A1
(43) Pub. Date: Aug. 6, 2026

(54) CONNECTOR

(71) Applicant: KONINKLIJKE PHILIPS N.V., EINDHOVEN (NL)

(72) Inventors: DIETER RENNER, BOBLINGEN (DE); MAXIMILIAN VOGELMANN, BOBLINGEN (DE); ULRICH SCHMITT-RADLOFF, BOBLINGEN (DE)

(21) Appl. No.: 19/149,120

(22) PCT Filed: Jan. 18, 2024
(86) PCT No.: PCT/EP2024/051141

§ 371 Date: Jul. 18, 2025

(30) Foreign Application Priority Data
Jan. 20, 2023 (EP) 23152591.6

(51) Int. Cl. H01R 13/6581; H01R 13/52; H01R 13/627

(52) U.S. Cl. CPC H01R 13/6581; H01R 13/5219; H01R 13/6273

(57) ABSTRACT

The present invention relates to a connector (1) configured to mate with a counterpart connector for data and/or power transfer. The connector comprises a central carrier wall (10), a plurality of pins (20) arranged through the central carrier wall (10), a pin carrier (40, 50), an electrically conductive shield (60), and one or more pre-guiding elements (70).

### FIELD OF THE INVENTION

The present invention relates to a connector configured to mate with a counterpart connector for data and/or power transfer.

### BACKGROUND OF THE INVENTION

Many different types of connectors for data and/or power connections are known. In terms of medical applications, connectors are e.g., used with stationary and/or mobile patient monitors (e.g., Philips Intellivue patient monitors) to connect them directly or via adapters or cables. For instance, a mobile patient monitor can be directly docked to a stationary patient monitor to synchronize them with respect to all medical data and to charge the battery of the mobile patient monitor.

A known connector is the IEEE 488 connector, also known as HP-IB (Hewlett-Packard Interface Bus) or GPIB (General Purpose Interface Bus) connector, which is a short-range digital communications 8-bit parallel multi-master interface bus connector.

Next generations of patient monitors and future application scenarios will demand an increased broadband width and/or bandwidth for secure high speed data transfer. Further requirements may be a compact outer size, high and stable signal quality, and ingress protection.

US 2017/271820 A1 discloses an electrical connector that is suitable to mate with another mating connector and that comprises an combined body, a grounding metal plate and an outer shielding shell. The combined body comprises a first terminal module and a second terminal module. The first terminal module has a first insulative piece and a plurality of first terminals. The first insulative piece has a first base portion and a first tongue portion. Each first terminal forms a first mating portion and a first soldering portion. The second terminal module has a second insulative piece assembled with the first insulative piece and a plurality of second terminals. The second insulative piece has a second base portion and a second tongue portion. Each second terminal forms a second mating portion and a second soldering portion. The grounding metal plate is interposed between the first terminal module and the second terminal module. The outer shielding shell surrounds an outer space of the first tongue portion and an outer space of the second tongue portion, and forms a mating cavity for insertion of the mating connector.

### SUMMARY OF THE INVENTION

It is an object of the present invention to provide a connector that can be used as interface providing an increased broadband width and/or bandwidth for secure high speed data transfer. It is a further object of the present invention to provide a connector that enables a smooth interface connector operation and/or facilitates automated blind mating of connectors with high reliability.

According to the present invention a connector configured to mate with a counterpart connector for data and/or power transfer is presented, the connector comprising:
a central carrier wall having a front surface, a back surface and a circumferential surface;
a plurality of pins arranged through the central carrier wall and having front ends protruding from the front surface and back ends protruding from the back surface, wherein the front ends are arranged along one or more pin rows on the front surface of the central carrier wall;
a pin carrier arranged on the front surface and having two or more pin carrier rows carrying the plurality of front ends of the plurality of pins;
an electrically conductive shield having a front-end circumferential shield portion circumferentially arranged around the front ends of the plurality of pins, a back-end circumferential shield portion covering at least part of the circumferential surface of the central carrier wall and an intermediate shield portion covering a portion of the front surface of the central carrier wall arranged between the front-end circumferential shield portion and the back-end circumferential shield portion; and
one or more pre-guiding elements protruding from the front surface of the central carrier wall beyond at least some of the front ends of the plurality of pins and beyond the front-end circumferential shield portion, wherein the one or more pre-guiding elements are arranged in the circumferential area around the front ends of the plurality of pins and in between the front ends of the plurality of pins and the front-end circumferential shield portion.

Preferred embodiments of the invention are defined in the dependent claims.

The present invention is based on the idea to provide an interface connector that features compact outer size, multi-row arrangement of an enlarged number of contact pins, covering connector shielding, and mechanical pre-guidance to achieve smooth interface connector operation. The connector is particularly configured to enable automated mating with a counterpart connector, for which purpose the one or more pre-guiding elements, which are protruding from the front surface of the central carrier wall beyond at least some of the front ends of the plurality of pins and beyond the front-end circumferential shield portion, are useful. The mating action can thus be performed easily via a sliding or snapping action which can be accomplished without wrenches or other tools. Further, the one or more pre-guiding elements provide a self-aligning function, which allows a small misalignment when mating, prevents the front-end circumferential shield portion from unintended deformation during blind mating and thus protects the shield and the pins from damage and wear. The connector may be configured as male or female connector that mates/can be connected with a corresponding female or male counterpart connector.

Generally, the connector can be used for connecting any kinds of devices, either directly or indirectly via cable and/or adapter. Preferably, the connector may be used at medical devices (e.g., patient monitor devices) as well as cables and adapters that are used to connect medical devices with each other to provide a high speed data transfer and/or to charge a medical device. The present invention represents a (stand-alone) multi pin row connector concept for several customer-specific applications.

In an embodiment, the one or more pre-guiding elements, which provide the mechanical pre-guidance, are circumferentially arranged in the complete circumferential area around the first ends of the plurality of pins and are arranged in between the plurality of front ends and the front-end circumferential shield portion. This further improves the pre-guidance function and facilitates mating of connectors.

The one or more pre-guiding elements are preferably arranged at a distance (in radial direction, i.e., in a direction from the center to the connector to the outer circumference of the connector) from the plurality of front ends and/or the front-end circumferential shield portion, i.e., there is preferably free space in between the one or more pre-guiding elements and the plurality of front ends and/or the front-end circumferential shield portion. Further, the one or more pre-guiding elements are preferably mounted directly at the front surface of the central carrier wall and protrude from it. The one or more pre-guiding elements are thus preferably separate elements arranged separately from the electrically conductive shield and the plurality of pins and the pin holder, i.e., they are preferably not integrated into or mounted directly at the shield or the pin carrier. This enables that the connector and the counterpart connector can be easily mated, wherein their respective components, in particular their front ends of the plurality of pins and their front-end circumferential shield portions, can easily slide into the free space(s) of the respective other connector. This arrangement further improves the automated blind mating of the connector and a counterpart connector.

Furthermore, the one or more pre-guiding elements are preferably made of a different material (most likely plastic) compared to the electrically conductive shield that is preferably made of metal. This allows an application-adequate material selection (e.g., to prevent from early wear of both mating ends).

According to another embodiment the front-end circumferential shield portion and/or the one or more pre-guiding elements have an asymmetric outer shape, in particular a D-Sub shape. This provides a poka-yoke function and prevents from fail-mating. Particularly the one or more pre-guiding elements may serve as mechanical keying/coding when the connector counterparts are getting mated to prevent from any kind of false connector orientation.

The electrically conductive shield may have another circumferential shield portion circumferentially arranged around the back ends of the plurality of pins. This further improves the shielding function and thus further improves the signal quality of the transferred signals. The electrically conductive shield may e.g., be a metal shield or a metalized plastic element or any other element that provides the function of shielding from undesired radiation.

The connector may further comprise a sealing circumferentially arranged around the circumferential surface of the central carrier wall and arranged on the outer surface of the back-end circumferential shield portion and/or on the circumferential surface of the central carrier wall adjacent to the end of the back-end circumferential shield portion. This integrated sealing prevents leakage when the connectors are mounted into the devices.

In another embodiment at least one of the front ends or pin rows of the front ends of the plurality of pins protrudes from the central carrier wall beyond the remaining front ends or pin rows. Thus, the front ends of the pins or complete pin rows are offset with respect to other front ends or other pin rows, which provides additional mechanical stability and protection from unintended deformation of pins during the connector mating process.

The connector may further comprise one or more snap connection elements, e.g. cable snap connection elements, protruding from the front surface of the central carrier wall and arranged outside of the front-end circumferential shield portion. This ensures that the connectors used with a cable cannot be inadvertently unmated, e.g., by pulling at the cable or the device.

Still further, the connector may comprise potting material on the front surface and/or the back surface of the central carrier wall. This avoids potential leakage through the connector front and back ends itself.

In an embodiment the pin carrier comprises one pin carrier spot per pin supporting the front end of the respective pin and, optionally, one or more dummy pin carrier spots or complete dummy pin carrier rows not supporting front ends of pins. The dummy (or blind) pin carrier spots allow eased modification and/or customized configuration of the connector through the manufacturer so that it can be used for various applications by just adding or removing pins as required.

The connector may further comprise an additional sealing arranged at the outer area of the front surface of the central carrier wall and at the front area of the circumferential surface of the central carrier wall adjacent to the front surface. This further improves the sealing functionality and particularly prevents from leakage into the connector interior spaces when two connectors are mated.

The width and/or height of the one or more pre-guiding elements decrease with increasing distance from the front surface of the central carrier wall. This inclined design eases smooth connector mating.

Preferably, the pin carrier rows are arranged in parallel. Hereby, two different kinds of arrangement (as male and female connector end) may be considered.

In an embodiment of a female connector the pin carrier comprises a central pin carrier bar, an upper pin carrier bar and a lower pin carrier bar, wherein one pin carrier row is arranged on the upper pin carrier bar facing the central pin carrier bar, another pin carrier row is arranged on the lower pin carrier bar facing the central pin carrier bar, and two other pin carrier rows are arranged on opposite surfaces of the central pin carrier bar facing the upper and lower pin carrier bar, respectively.

In an embodiment of a male connector the pin carrier comprises two parallel pin carrier bars, wherein first and second pin carrier rows are arranged on opposite surfaces of a first pin carrier bar and the third and fourth pin carrier rows are arranged on opposite surfaces of a second pin carrier bar.

### BRIEF DESCRIPTION OF THE DRAWINGS

These and other aspects of the invention will be apparent from and elucidated with reference to the embodiment(s) described hereinafter. In the following drawings:

FIG. 1 shows different views of a male version of a first embodiment of the connector according to the present invention.

FIG. 2 shows different views of a female version of the first embodiment of the connector according to the present invention.

FIG. 3 shows the male version and the female version of the first embodiment of the connector in mated and unmated state.

FIG. 4 shows front views of a male version and a female version of a second embodiment of the connector according to the present invention.

FIG. 5 shows front views of a male version and a female version of a third embodiment of the connector according to the present invention.

FIG. 6 shows a front view and a rear view of a male version of a fourth embodiment of the connector according to the present invention.

FIG. 7 shows a front view of a female version of a fifth embodiment of the connector according to the present invention and a side view of both versions in unmated and mated state.

FIG. 8 shows front views of a male version and a female version of a sixth embodiment of the connector according to the present invention.

FIG. 9 shows a rear view of a seventh embodiment of the connector according to the present invention.

FIG. 10 shows a front view of an eighth embodiment of the connector according to the present invention including a protection cap in disassembled and assembled state.

FIG. 11 shows a front view of male version of a nineth embodiment of the connector according to the present invention and a front view of both versions in unmated and mated state.

FIG. 12 shows a front view of female version of a tenth embodiment of the connector according to the present invention.

### DETAILED DESCRIPTION OF THE INVENTION

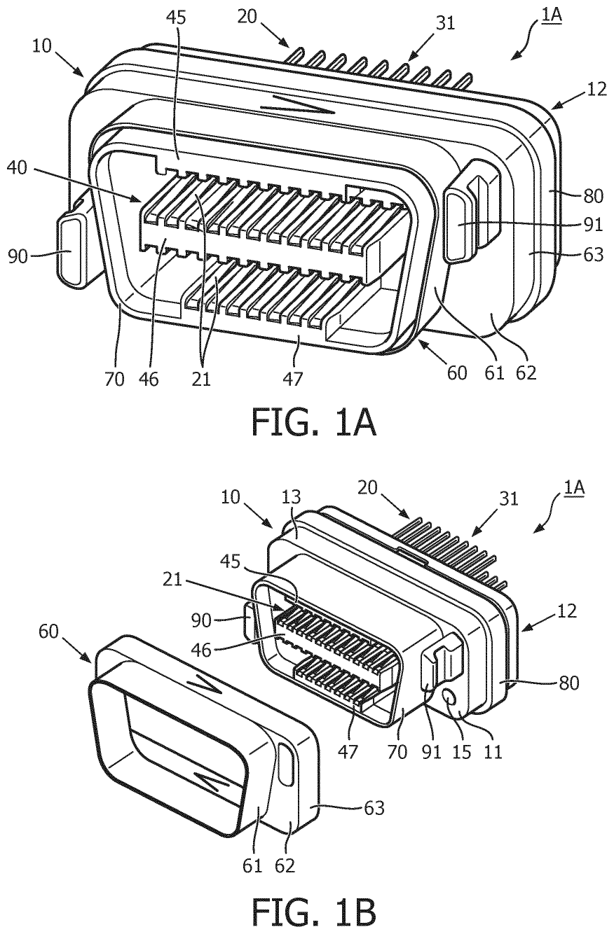

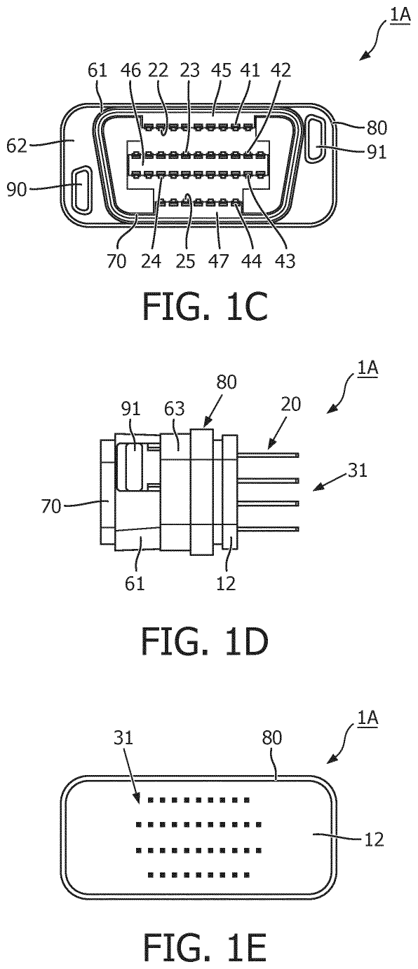

FIG. 1 shows different views of a male version of a first embodiment of the connector 1A according to the present invention. FIG. 1A shows a perspective view, FIG. 1B shows an exploded perspective view, FIG. 1C shows a front view, FIG. 1D shows a side view, and FIG. 1E show a rear view. The connector 1 comprises a central carrier wall 10 having a front surface 11, a back surface 12 and a circumferential surface 13. A plurality of pins 20 are arranged through the central carrier wall 10, the pins having front ends 21 protruding from the front surface 11 and back ends 31 protruding from the back surface 12. The front ends 21 are generally arranged along one or more (preferably two or more, more preferably three or more) pin rows, in this embodiment four pin rows 22, 23, 24, 25, on the front surface 11 of the central carrier wall 10. The back ends 31 may be connected to wires of a cable and may be arranged as straight ends, but can also be inclined or angled as desired, e.g., to allow a stacked board setup inside a device comprising the connector.

A pin carrier 40 is arranged on the front surface, which has two or more (preferably three or more) pin carrier rows, in this embodiment four pin carrier rows 41, 42, 43, 44, carrying the plurality of front ends 21 of the plurality of pins 20. Preferably, there is one pin carrier row per pin row, all preferably arranged in parallel. Generally, however, there may be more pin carrier rows than pin rows, i.e., there may be one or more dummy/blind pin carrier rows for customization of the connector to arrange a desired number of pins at desire pin carrier spots as required. Thus, in exemplary implementations of the connector there may be e.g., be one pin row and two pin carrier rows (i.e., one dummy pin carrier row), or there may be two pin rows and three or four pin carrier rows (i.e., one or two dummy pin carrier rows) or there may be three or four pin rows and three or four pin carrier rows (i.e., zero or one dummy pin carrier row).

In this embodiment of a male connector 1A there are four pin rows and four pin carrier rows. The pin carrier 40 comprises a central pin carrier bar 45, an upper pin carrier bar 46 and a lower pin carrier bar 47. One pin carrier row 41 is arranged on the upper pin carrier bar 46 facing the central pin carrier bar 46, another pin carrier row 44 is arranged on the lower pin carrier bar 47 facing the central pin carrier bar 46, and two other pin carrier rows 42, 43 are arranged on opposite surfaces of the central pin carrier bar 46 facing the upper and lower pin carrier bar 45, 47, respectively.

The connector 1A further comprises an electrically conductive shield, in the exemplary embodiments described herein a metal shield 60, which is separately shown in the exploded view of FIG. 1B. The metal shield 60 has a front-end circumferential shield portion 61 circumferentially arranged around the front ends 21 of the plurality of pins 20, a back-end circumferential shield portion 63 covering at least part of the circumferential surface 13 of the central carrier wall 10 and an intermediate shield portion 62 covering a portion of the front surface 11 of the central carrier wall 10 arranged between the front-end circumferential shield portion 61 and the back-end circumferential shield portion 63.

A ground contact 15 may be integrated into the connector (female and male versions), e.g., at any portion of the central carrier wall 10 (for example into the front surface 11 in the embodiment shown in FIG. 1B). This ground contact 15 enables grounded shield connection.

A pre-guiding element 70 projecting beyond at least some of the front ends 21 of the plurality of pins 20 and the front-end circumferential shield portion 61, i.e., it protrudes farther from the front surface 11 of the central carrier wall 10 than the front ends 21 of the plurality of pins 20 and the front-end circumferential shield portion 61. The pre-guiding element 70 is arranged in the circumferential area around the front ends 21 of the plurality of pins 20 and in between the front ends 21 of the plurality of pins 20 and the front-end circumferential shield portion 61.

In this embodiment the pre-guiding element 70 is circumferentially arranged in the complete circumferential area around the first ends 21 of the plurality of pins 20 and in between the plurality of front ends 21 and the front-end circumferential shield portion 61. Further, in this embodiment, the pre-guiding element 70 is integrally formed with the upper and lower pin carrier bars 45, 47.

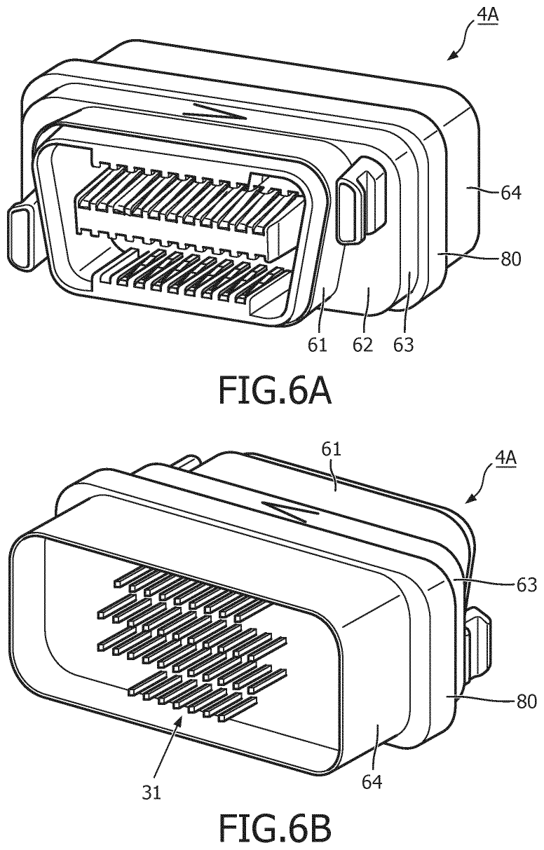

In this embodiment the connector 1A further comprises a sealing 80 circumferentially arranged around the circumferential surface 13 of the central carrier wall 10. Further, the sealing 80 may be arranged on the outer surface of the back-end circumferential shield portion 63 (as e.g., shown in FIG. 6) and/or on the circumferential surface 13 of the central carrier wall 10 adjacent to the end of the back-end circumferential shield portion 63.

Still further, in this embodiment the connector 1A comprises one or more (in this embodiment two) snap connection elements 90, 91 protruding from the front surface 11 of the central carrier wall 10 and arranged outside of the front-end circumferential shield portion 61.

Generally, the front-end circumferential shield portion 61 and the pre-guiding element 70 may have any shape, as long as they fit with the corresponding elements of a counterpart connector. In this embodiment, the front-end circumferential shield portion 61 and the pre-guiding element 70 have an asymmetric outer shape, in particular a D-Sub shape, to enable fail-safe mating between connector 1A and a counterpart connector 1B (as shown in FIG. 1B).

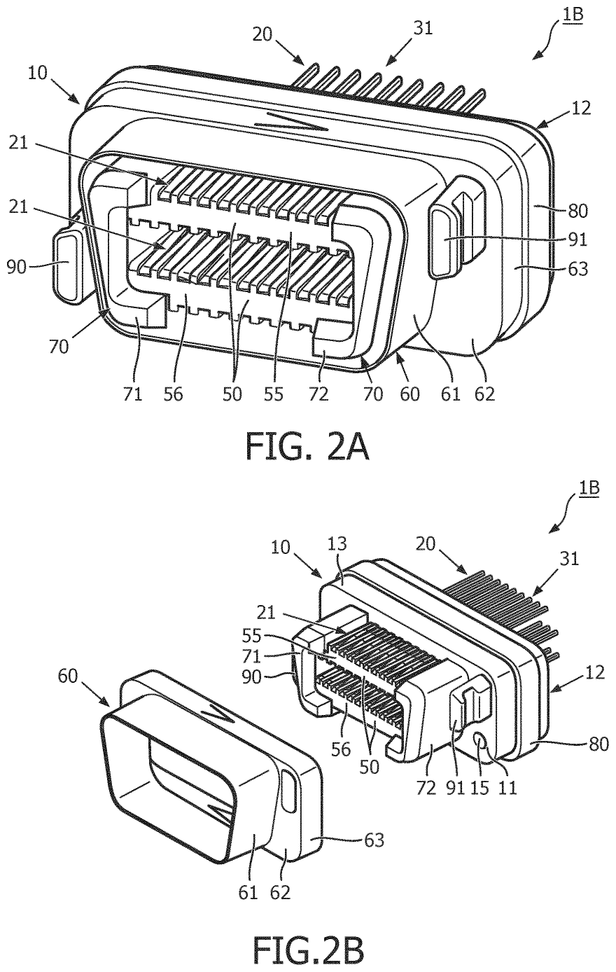

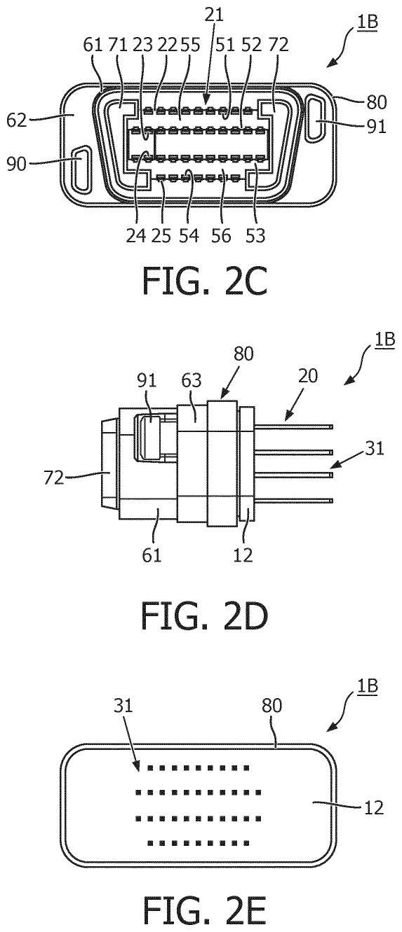

FIG. 2 shows different views of a female version of the first embodiment of the connector 1B according to the present invention. FIG. 2A shows a perspective view, FIG. 2B shows an exploded perspective view, FIG. 2C shows a front view, FIG. 2D shows a side view, and FIG. 2E shows a rear view. Many parts of the female version are identical to the parts of the male version shown in FIG. 1 and thus are indicated with the same reference signs. Some other parts are somewhat modified to ensure that the connector 1B can be mated with the counterpart connector 1A. Those other parts will be explained in the following.

In this embodiment of a female connector 1B the pin carrier 50 is formed differently than the pin carrier 40 of the male connector 1A. The pin carrier 50 comprises two parallel pin carrier bars 55, 56, wherein first and second pin carrier rows 51, 52 are arranged on opposite surfaces of a first pin carrier bar 55 and the third and fourth pin carrier rows 53, 54 are arranged on opposite surfaces of a second pin carrier bar 56. Thus, when connected, each of the front ends 21 of the pins 20 of the connector 1B gets in contact with a corresponding front end 21 of a pin 20 of the connector 1A.

Further, in this embodiment, the pre-guiding element 70 comprises two sub-elements 71, 72 that are arranged on opposite sides at the lateral ends of the pin carrier 40. These sub-elements have a width and height that decrease with increasing distance from the front surface 11 of the central carrier wall 10, thus defining an inclined front-end of the sub-elements 71, 72 that ameliorates introducing the connector 1B into the counterpart connector 1A.

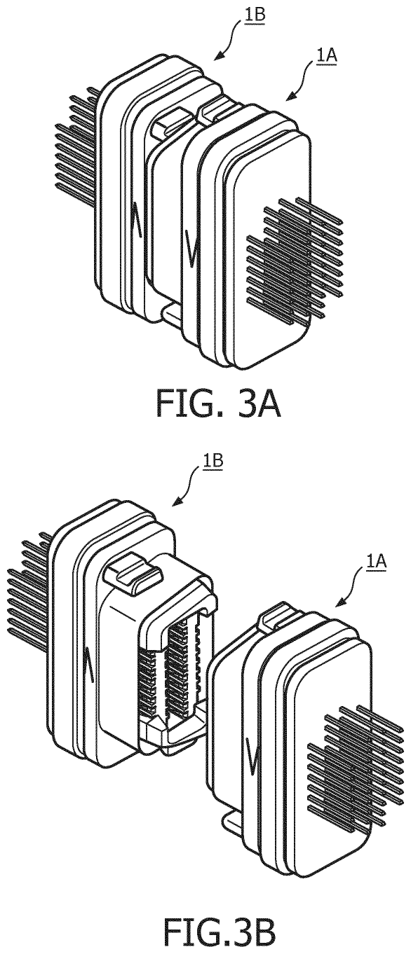

FIG. 3 shows the male version and the female version of the first embodiment of the connector in mated (coupled) state (FIG. 3A) and unmated (decoupled) state (FIG. 3B). As demonstrated, the two connectors 1A and 1B mate properly and thus allow the desired compact design of the connector interface having a multi-row pin configuration, which may provide sufficient space e.g., for up to 38 (or more) pins. The height of the metal shield 60 may be reduced, as shown in FIG. 3, e.g., there may be an offset/recess between the metal shield 60 and the pre-guiding element 70 which protrudes farther from the central carrier wall 10 than the metal shield 10. Further, the metal shield 60 covers the entire connector interface in the mated state. Still further, the poka-yoke (in this example achieved by the D-Sub shape) can be seen in FIG. 3 as the connector ends only mate in the designated orientation.

The D-Sub shaped connector design provides connector coding functionality, while the connector's interior is protected by the surrounding material, which may be made of plastics. Furthermore, this design prevents from contact through the operator's fingers (in terms of IP classification requirements). The central carrier wall (also referred to as connector inserts), which may be injection molded and made of plastic material, shows integrated pre-guiding element(s), e.g., plastic guiding pins, which allow a smooth connector mating operation.

Preferably, the (grounded sheet) metal shield is inseparably mounted with the central wall connector insert to cover the connector ends and to enable shielding function, when both connector ends are mated to prevent from interference (i.e., foreign device signal crosstalk/noise). To provide ingress protection, both connector ends may include potting (not illustrated) in the area of the connector front and/or back ends (i.e., potting material on the front surface 11 and/or the back surface 12 of the central carrier wall 10) to avoid potential leakage through the connector ends itself. The mounted sealing in the area of the connector back provides additional sealing function when assembled into a device, e.g., into a patient monitor. The integrated cable mounting snap fit option provides beneficial device user operation, due to customer known usability concept.

The connector according to the present invention can thus be used as a docking solution and/or as an adapter cable interface, i.e., the connector may be arranged at a cable, at an adapter and/or at a device to provide data and/or power transfer. Additional benefits of the proposed connector are that the connector design allows common soldering operations onto a PCA (Printed Circuit Assembly) and with flexprints. In addition, the pin end can be designed to allow straight and/or angled soldering operation. Besides a docking connector interface, the connector may also serve as a cable connector. This feature allows maximum interconnectivity of multiple devices. Still further, connector design scalability is provided, i.e., the connector design may be modified according to specific requirements or demands of the manufacturer, customers, standards, or other regulation.

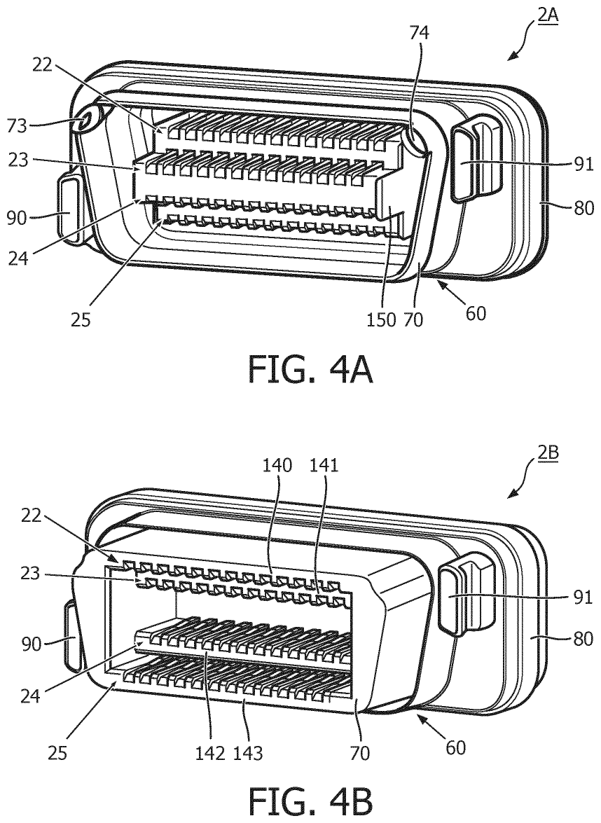

FIG. 4 shows front views of a male version (FIG. 4A) and a female version (FIG. 4B) of a second embodiment of the connector 2A, 2B according to the present invention. Different from the first embodiment shown in FIGS. 1-3, at least one of the front ends 21 or pin rows of the front ends 21 of the plurality of pins 20 protrudes from the central carrier wall beyond the remaining front ends 21 or pin rows. For instance, in the female connector 2A, the uppermost pin row 22 projects the second uppermost pin row 23, and the lowermost pin row 25 projects the second lowermost pin row 24. Thus, the pin ends of the pin rows 22 and 25 end within a first plane, and the pin ends of the pin rows 23 and 24 end within a second plane that is closer to the front surface 11 of the central wall 10 than the first plane. Similarly, in the male connector 2A, the second uppermost pin row 23 projects the uppermost pin row 22, and the second lowermost pin row 24 projects the lowermost pin row 25. Thus, the pin ends of the pin rows 22 and 25 end within a first plane, and the pin ends of the pin rows 23 and 24 end within a second plane that is farther away from the front surface 11 of the central wall 10 than the first plane.

The pin carrier rows are preferably arranged in the same manner and with the same relative arrangement with respect to each other than the corresponding pin rows. In the female connector 2B the pin carrier 40 comprises four separate parallel pin carrier bars 140, 141, 142, 143 carrying the front ends 21 of the pins 20, wherein the uppermost and lowermost pin carrier bars 140, 143 at the same time form part of the pre-guiding element 70. In the male connector 2A the pin carrier 50 comprises a single pin carrier bar 150 carrying the front ends 21 of the pins 20 at different pin carrier rows.

The male connector 2A of this embodiment comprises pre-guiding elements in the form of integrated plastic pins 73, 74 arranged in the upper corners at a circumferential pre-guiding element 70.

This second embodiment may require additional connector mating depth compared to the first embodiment. This connector design, however, allows various locations of the pin contact points due to the offset pin alignment inside the connector. Further, this multiple row offset pin configuration provides more mechanical stability during the mating process of both connector ends 2A, 2B.

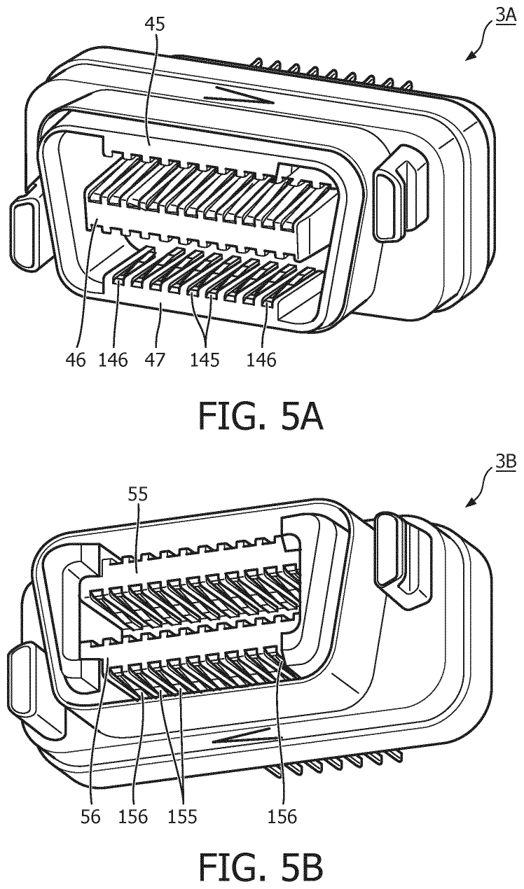

FIG. 5 shows front views of a male version (FIG. 5A) and a female version (FIG. 5B) of a third embodiment of the connector 3A, 3B according to the present invention. This embodiment is similar to the first embodiment, but in this embodiment the pin carriers 40, 50 of the male version and the female version do not only comprise one pin carrier spot 145, 155 per pin supporting the front end of the respective pin, but additionally comprise one or more dummy/blind pin carrier spots 146, 156 (in one or more pin carrier rows) not supporting a front end of a pin. This allows a customized connector configuration that satisfies specific customer needs. For instance, in the exemplary embodiment shown in FIG. 5, both connectors 3A, 3B allow a 38+2 pin configuration due to the two dummy pin spots 146, 156.

FIG. 6 shows a front view (FIG. 6A) and a rear view (FIG. 6B) of a male version of a fourth embodiment of the connector 4A according to the present invention. Compared to the first embodiment, in this embodiment the metal shield 60 has another circumferential shield portion 64 circumferentially arranged around the back ends 31 of the plurality of pins 20. Thus, the sheet metal shielding is enlarged to cover the entire length of the pins including the solder joints (not shown) at which wires (not shown) are soldered to the back ends 31. The sealing 80 is formed as outer seal, which is mounted on top of the intermediate shield portion 62. The enlarged shielding ensures an entire connector “front-to-back” shielding function to further improve protection against interference, due to foreign device signal crosstalk and noise.

It shall be noted that the female version that is not explicitly shown, may comprise the same circumferential shield portion 64.

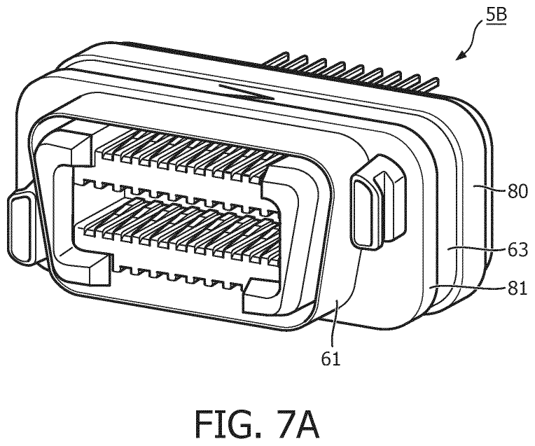

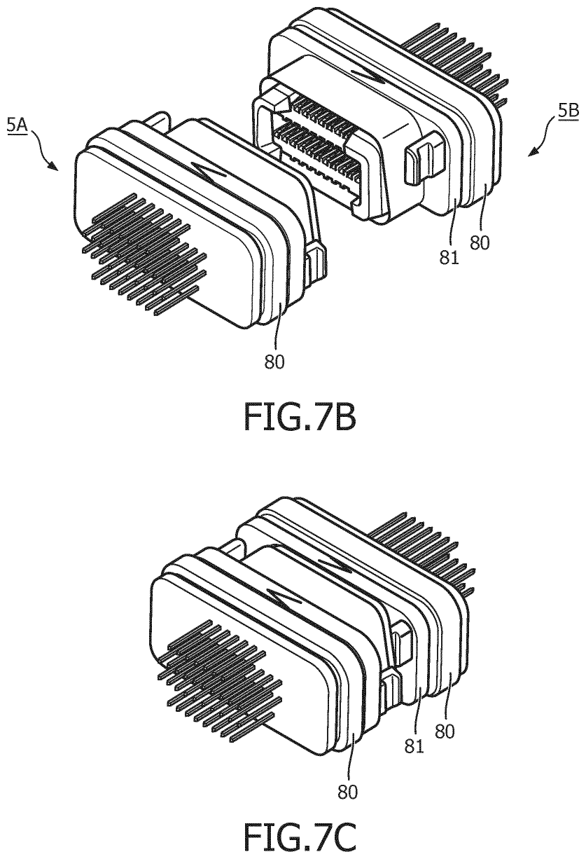

FIG. 7 shows a front view of a female version (FIG. 7A) of a fifth embodiment of the connector 5B according to the present invention and the female connector 5B and the male connector 5A of this embodiment of the connector in unmated state (FIG. 7B) and mated state (FIG. 7C). This embodiment of the female connector 5B further comprises an additional sealing 81 arranged at the outer area of the front surface 11 of the central carrier wall 10 and at the front area of the circumferential surface 13 of the central carrier wall 10 adjacent to the front surface 11. The additional sealing 81 may particularly be in contact with the metal shield 60, in particular the surfaces of the front-end circumferential shield portion 61, the back-end circumferential shield portion 63 and the intermediate shield portion 62.

The male connector 5A may not comprise such an additional sealing but may be designed in the same way as the first embodiment shown in FIG. 1.

In the mated state shown in FIG. 7C the additional sealing 81 is assembled in between both connector ends and prevents from leakage into the connector interior spaces, when both connector ends are mated. In an embodiment the additional sealing 81 may be designed to enable an axial and/or radial sealing function. Thus, the risk of short circuits between pins is minimized, even in case the connector gets sprayed with liquids (e.g., disinfection or cleaning agents within a hospital environment). FIG. 8 shows front views of a male version (FIG. 8A) and a female version (FIG. 8B) of a sixth embodiment of the connector 6A, 6B according to the present invention. This embodiment has a mirrored pin configuration and integrated dome-shaped plastic pre-guiding pins 75, 76 at the male connector 6A as pre-guiding elements that fit into corresponding recesses 77, 78 at the female connector 6B. This embodiment allows a smaller connector design, but the number of contact pins is limited, but may be decreased/increased as required as shown in the other embodiments. The same pre-guiding elements may be used in the other embodiments of the connector.

The metal shield provided according to the present invention may enable a reduced height of the connector, due to sheet metal protection during connector operation and transport. The connector shielding function may particularly be provided in mated state of the connector ends. Further, a potting compound may provide a collar design (front and back ends). In other embodiments, potting collar may be an integrated metal shield function. The metal shield may further provide a straight and/or formed/shaped front-end (e.g., in the form of a trumpet or other desired shape) to allow optional electrical contact between male and female connector ends in the mated state. The formed/shaped back-end may further prevent from sealing slippage during connector assembling.

The pins may have an offset pin alignment and thus may provide operator's finger protection (e.g., avoidance of an electrical shock according to IP classification). The back ends of the pins may have an angled and/or straight alignment, which allows a stacked board setup according to specific customer needs. A bent state of the back ends of the pins may provide mechanical self-supporting benefits during shock and/or vibration impacts. The recessed pin configuration may provide further benefits, due to increased mechanical connector robustness.

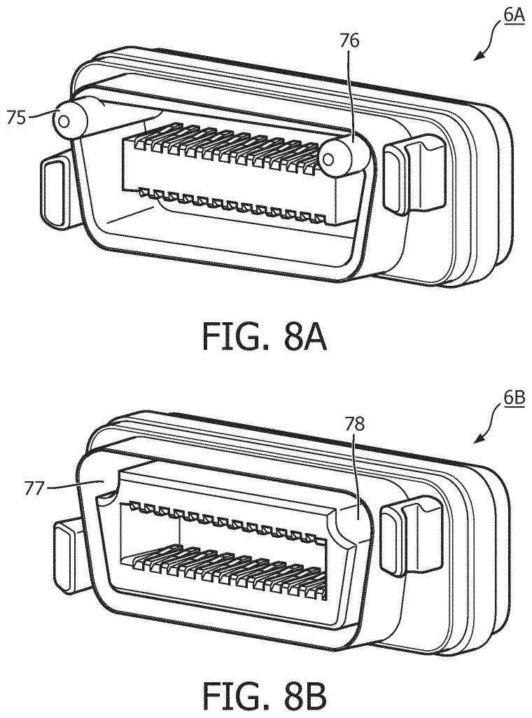

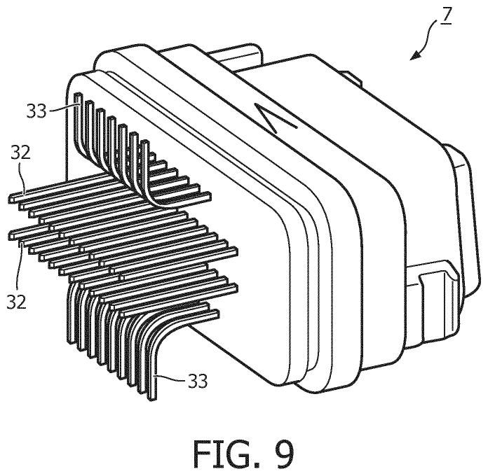

FIG. 9 shows a rear view of a seventh embodiment of the connector 7 according to the present invention. In this embodiment some of the back ends 32 of the pins are straight and some other of the back ends 33 of the pins are bent. Such an arrangement may generally be used in all other embodiments of the connector as well. It may be used to separate the parameter signals into different/segregated pin rows which allows to group the parameter signal pins via multiple pin rows. For instance, ECG signals may be grouped in the top pin row, SpO2 signals might be grouped in the second pin row below, etc.

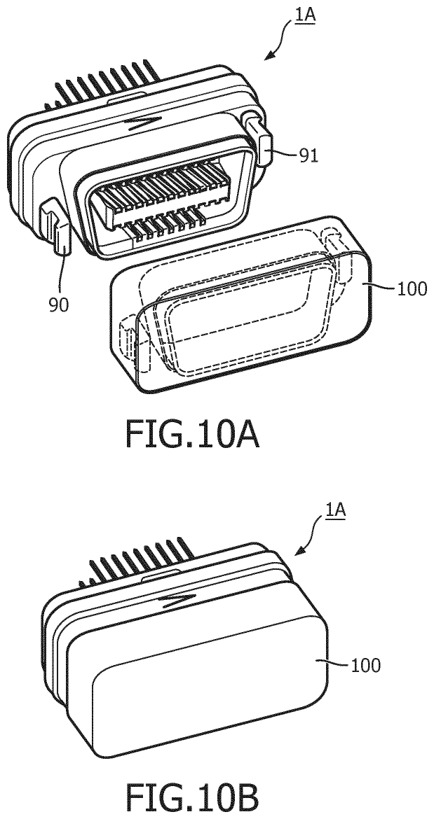

FIG. 10 shows a front view of an eighth embodiment of the connector according to the present invention including a protection cap in disassembled state (FIG. 10A) and assembled state (FIG. 10B). In this example the male connector 1A as shown in FIG. 1 is shown including a protection cap 100 covering at least the front ends 21 of the pins in the assembled state. The cable mounting features, in this embodiment the snap connection elements 90, 91, are intentionally placed outside the pin carrier area.

This enables the use of the captive protection cap 100 and enables compatibility with such a cap. The protection cap 100 prevents the interior metal parts from corrosion, contamination and/or mechanical deformation (e.g., in a rough out-of-hospital environment).

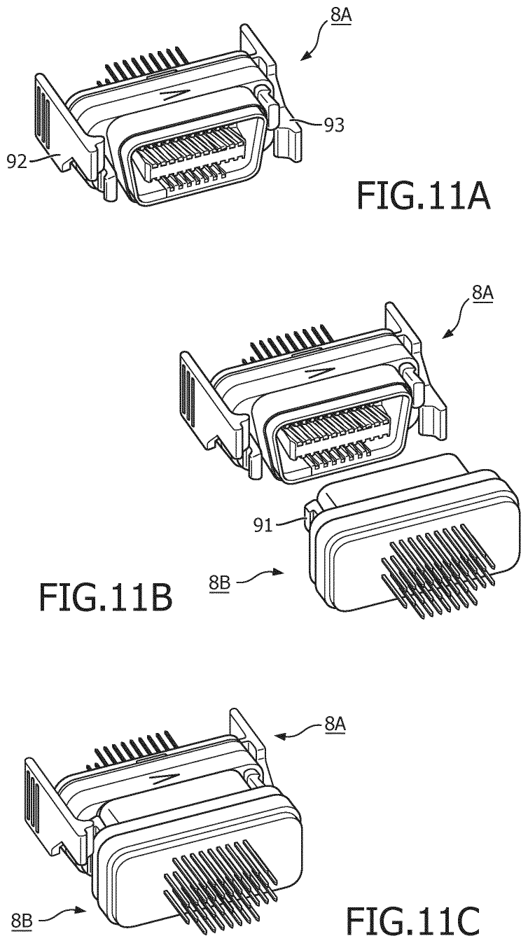

FIG. 11 shows a front view (FIG. 11A) of a male version of a nineth embodiment of the connector 8A according to the present invention and a front view of both versions in unmated state (FIG. 11B) and mated state (FIG. 11C). In this embodiment, the male connector 8A comprises exterior cable mounting levers 92, 93 arranged at the outer surface on opposite sides of the connector 8A. The levers 92 lock the male connector 8A securely with the counterpart connector 8B, as it fits the opposite cable mounting snap connectors 90, 91 of the female connector 8B properly and thus ensures secure connector mating.

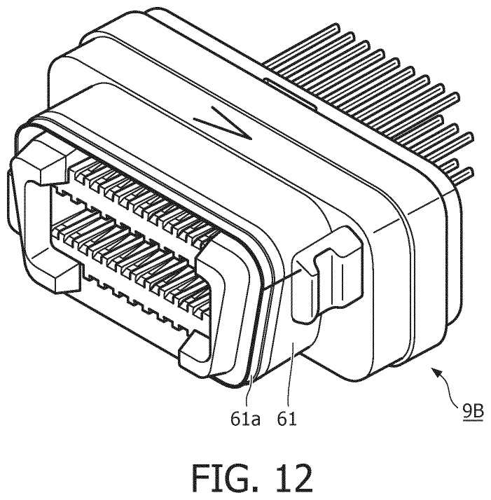

FIG. 12 shows a front view of a female version of a tenth embodiment of the connector 9B according to the present invention. In this embodiment the metal shield 60 is modified. The front-end circumferential shield portion 61, in particular its outer end 61a, is shaped/formed (e.g., having an embossed shape), to ensure electrical contact between male and female connectors in the mated state.

In the mated state, the metal shielding may cover the entire pin length front-to-back (from the contact tip up to the solder joints).

The back-end metal shield portion may include punched recesses (exemplarily illustrated as V-shaped recess in the FIGS) in order to allow mechanical·xation through plastic deformation with the plastic made counterparts (e.g., pin carrier).

The potting compound may provide mechanical fixation of the pressed pins to prevent from movement inside the pin carrier (in the assembled state) due to vibration and/or shock impact (abuse).

The cable mounting elements, e.g., in the shape of snap connection elements, are intentionally placed outside the pin carrier due to optional use/compatibility with a protection cap to prevent the metal parts from corrosion, contamination and/or mechanical deformation (e.g., out-of-hospital environments).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A connector configured to mate with a counterpart connector for data and/or power transfer, the connector comprising:
a central carrier wall having a front surface, a back surface and a circumferential surface;
a plurality of pins arranged through the central carrier wall and having front ends protruding from the front surface and back ends protruding from the back surface, wherein the front ends are arranged along one or more pin rows on the front surface of the central carrier wall;
a pin carrier arranged on the front surface and having two or more pin carrier rows-carrying the plurality of front ends of the plurality of pins;
an electrically conductive shield having a front-end circumferential shield portion circumferentially arranged around the front ends of the plurality of pins, a back-end circumferential shield portion covering at least a part of the circumferential surface of the central carrier wall and an intermediate shield portion covering a portion of the front surface of the central carrier wall arranged between the front-end circumferential shield portion and the back-end circumferential shield portion; and
one or more pre-guiding elements protruding from the front surface of the central carrier wall beyond at least some of the front ends of the plurality of pins and beyond the front-end circumferential shield portion, wherein the one or more pre-guiding elements are arranged in the circumferential area around the front ends of the plurality of pins and in between the front ends the plurality of pins and the front-end circumferential shield portion-64.

2. The connector according to claim 1,
wherein the one or more pre-guiding elements are circumferentially arranged in the complete circumferential area around the first ends of the plurality of pins and are arranged in between the plurality of front ends and the front-end circumferential shield portion.

3. The connector according to claim 1,
wherein the front-end circumferential shield portion and/or the one or more pre-guiding guiding elements have an asymmetric outer shape.

4. The connector according to claim 1,
wherein the electrically conductive shield has another circumferential shield portion circumferentially arranged around the back ends of the plurality of pins.

5. The connector according to claim 1,
further comprising a sealing circumferentially arranged around the circumferential surface of the central carrier wall and arranged on the outer surface of the back-end circumferential shield portion and/or on the circumferential surface of the central carrier wall adjacent to the end of the back-end circumferential shield portion.

6. The connector according to claim 1, wherein at least one of the front ends or pin rows of the front ends of the plurality of pins protrudes from the central carrier wall beyond the remaining front ends or pin rows.

7. The connector according to claim 1,
further comprising one or more snap connection elements protruding from the front surface of the central carrier wall and arranged outside of the front-end circumferential shield portion.

8. The connector according to claim 1,
further comprising potting material on the front surface and/or the back surface of the central carrier wall.

9. The connector according to claim 1,
wherein the pin carrier comprises one pin carrier spot per pin supporting the front end of the respective pin.

10. The connector according to claim 1,
further comprising an additional sealing arranged at the outer area of the front surface of the central carrier wall and at the front area of the circumferential surface of the central carrier wall adjacent to the front surface.

11. The connector according to claim 1,
wherein the width and/or height of the one or more pre-guiding elements decrease with increasing distance from the front surface of the central carrier wall.

12. The connector according to claim 1,
wherein the pin carrier are arranged in parallel.

13. The connector according to claim 12,
wherein the pin carrier comprises a central pin carrier bar an upper pin carrier bar and a lower pin carrier bar wherein one pin carrier row is arranged on the upper pin carrier bar facing the central pin carrier bar, another pin carrier row is arranged on the lower pin carrier bar facing the central pin carrier bar, and two other pin carrier rows are arranged on opposite surfaces of the central pin carrier bar facing the upper and lower pin carrier bar, respectively.

14. The connector according to claim 12,
wherein the pin carrier comprises two parallel pin carrier bars wherein first and second pin carrier rows are arranged on opposite surfaces of a first pin carrier bar and the third and fourth pin carrier rows are arranged on opposite surfaces of a second pin carrier bar

15. A device having a connector according to claim 1.

16. The connector according to claim 2, wherein the one or more pre-guiding elements are arranged at a distance from the plurality of front ends and/or the front-end circumferential shield portion.

17. The connector according to claim 3, wherein the asymmetric outer shape is a D-Sub shape.

18. The connector according to claim 9, wherein the pin carrier further comprises one or more dummy pin carrier spots not supporting a front end of a pin

19. The device of claim 15, wherein the device is at least one of a medical device, a cable, or an adapter.
